(19) United States
(12) Patent Application Publication
(10) Pub. No.: US 2006/0264540 A1
(43) Pub. Date: Nov. 23, 2006

(54) Stabilizer blend for improved chlorine resistance

(76) Inventor: Michael E. Gelbin, Middlebury, CT (US)

Correspondence Address: Michael P. Dilworth;CROMPTON CORPORATION, Benson Road, Middlebury, CT, 06749, US

(21) Appl. No.: 11/133,911

(22) Filed: May 19, 2005

(51) Int. Cl. C08K 5/34

(52) U.S. Cl. 524/102

(57) ABSTRACT

A method for increasing the stability of a thermoplastic resin in the presence of water is disclosed wherein said method comprises adding to said resin a stabilizing amount of a blend of: (A) at least one aromatic amine antioxidant; and (B) at least one sterically hindered phenol antioxidant. Such stabilized resins, which are preferably high density polyethylene, are especially useful for the fabrication of pipes for the transport of water, particularly chlorinated potable water.

### BACKGROUND OF THE INVENTION

1. Field of the Invention

The present invention relates to a stabilizer blend for polymeric thermoplastic resin compositions. More particularly, the present invention relates to a stabilizer blend for polymeric thermoplastic resin compositions that affords improved resistance to degradation caused by chlorinated water.

2. Description of Related Art

It is known in the art that hot water pipe made from plastic materials is subject to premature mechanical failure owing to stress related crack growth. The visible result of this failure is a water leak in the pipe caused by formation of cracks or pinholes. It is further known that premature failure of the plastics may result from an extraction of the antioxidants/stabilizers present in the plastic material by hot water. It is also generally known that once the antioxidants are depleted by extraction, the plastic is no longer protected, and will consequently suffer mechanical failure from thermo-oxidative degradation.

In the United States, chlorine is added to potable water to disinfect it. The presence of chlorine, however, has given rise to concerns over the stability of plastic pipe that transports the water. In fact, that concern has led to standard test methods that measure the resistance of plastic water pipe to chlorine.

Several years ago a plastic pipe plumbing system made of polybutene-1 was marketed in the United States. This system used polyacetal fittings to join the pipes. Rather soon after its introduction, this system became plagued by reports from the field about premature failure. What happened was that the polyacetal fittings were prone to develop water leaks. Against the background of multiple litigations, manufacturers and distributors of the pipe system began an investigation into the cause of the mechanical failure of the polyacetal fittings. It was generally concluded that the polyacetal could not stand up to the deleterious effect of chlorine. (See Broutman, L. J. et al., ANTEC 1999, 3366, and Lewis, P. R., ANTEC 2000, 3125).

Recent interest in plastic water pipes has focused on high and medium density polyethylene. In its cross-linked variation, a typical end use is in hot water applications. Regular polyethylene water pipe is used as water distribution pipe, and in drainage and sewer applications. Polyethylene-based water pipe may sometimes contain carbon black.

In the context of experience with polybutene-1 plumbing systems, concern has arisen over the resistance of polyethylene to chlorinated water. In fact, the ASTM has released a relevant standard test method for both polyethylene and cross-linked polyethylene to address the issue (ASTM Standard Test Methods F 2263 and F 2023).

It is generally known that hot water by itself can deplete any stabilizers present in polyethylene pipes (See Kramer, E. et al., Kunststoffe 73:11 (1983), which describes an investigation of the aging characteristics of hot water pipe made from polybutene-1 and crosslinked polyethylene; Juskeviciute, S. et al., Mater. Vses. Simp. Vopr. Proizvod. Primen. Trub. Detalei Truboprovodov Polietilena (1966) 134, which describes the water extraction of antioxidants from high-pressure polyethylene films; and Pfahler, G. et al., Kunststoffe 78:142 (1988), which pertains to the extraction profile of several phenolic antioxidants from polypropylene and high density polyethylene formulations).

It is likewise documented that the presence of chlorine in water may accelerate the plastics failure process (See Hassinen, J. et al., Polym. Degrad. & Stab. 84:261 (2004); Gill, T. S. et al., Proceedings of the Plastic Pipes X Conference, Gothenburg, 1998; Tanaka, A. et al., Proceedings of the Plastic Pipes X Conference, Gothenburg; 1998; Ifwarson, M. et al., Proceedings of the Plastic Pipes X Conference, Gothenburg; 1998; and Dear, J. P. et al., Polymers & Polymer Composites 9:1 (2001)).

U.S. Pat. No. 6,541,547 discloses polyolefin mouldings that are stable on permanent contact with extracting media that comprise, as stabilizers, a selected mixture comprising an organic phosphite or phosphonite and a specially selected group of sterically hindered phenols or a certain group of sterically hindered amines. In addition, a selected three-component mixture comprising a phosphite or phosphonite, a phenolic antioxidant and a certain group of sterically hindered amines is said to be particularly suitable as stabilizer for polyolefin moldings which are in permanent contact with extracting media.

The disclosures of the foregoing are incorporated herein by reference in their entirety.

### SUMMARY OF THE INVENTION

There is a continuing demand to improve the resistance of plastic water pipe to the deleterious effect of chlorine on the plastic material of which the pipe is made. The present invention relates to a stabilizer blend comprising an aromatic amine stabilizer and a sterically hindered phenol for polymeric thermoplastic resin compositions affording improved resistance to degradation caused by chlorinated water.

In another aspect, the present invention relates to a composition comprising a thermoplastic resin and a stabilizer comprising a blend of an aromatic amine stabilizer and a hindered phenol.

More particularly, the present invention is directed to a method for increasing the stability of a thermoplastic resin in the presence of water comprising adding to said resin a stabilizing amount of a blend of:

(A) at least one aromatic amine antioxidant; and

(B) at least one sterically hindered phenol antioxidant.

In another aspect, the present invention is directed to a pipe for transporting water wherein said pipe is prepared from a composition comprising a thermoplastic resin and a stabilizing amount of a blend of:

(A) at least one aromatic amine antioxidant; and

(B) at least one sterically hindered phenol antioxidant.

### DESCRIPTION OF THE PREFERRED EMBODIMENT(S)

As noted above, it is known in the art that the presence of a stabilizer blend comprising a phosphite stabilizer and a hindered phenol stabilizer can improve the resistance of a thermoplastic material, such as polyethylene, to an extracting medium, such as water, hot water and chlorinated water.

It has now been found that when a secondary aromatic amine antioxidant is substituted for the phosphite component, the resultant amine-phenolic blend affords superior protection to HDPE from the degrading effect of chlorine.

This improved resistance for the blend comprising an aromatic amine and a hindered phenol stabilizer was verified both in the absence and the presence of carbon black.

The aromatic amine antioxidants that are employed in the practice of the present invention can be hydrocarbon substituted diarylamines, such as, aryl, alkyl, alkaryl, and aralkyl substituted diphenylamine antioxidant materials. A nonlimiting list of commercially available hydrocarbon substituted diphenylamines includes substituted octylated, nonylated, and heptylated diphenylamines and para-substituted styrenated or α-methyl styrenated diphenylamines. The sulfur-containing hydrocarbon substituted diphenylamines, such as p-(p-toluenesulfonylamido)-diphenylamine, are also considered as part of this class.

Hydrocarbon-substituted diarylamines that are useful in the practice of this invention can be represented by the general formula
Ar—NH—Ar′
wherein Ar and Ar′ are independently selected aryl radicals, at least one of which is preferably substituted with at least one alkyl radical. The aryl radicals can be, for example, phenyl, biphenyl, terphenyl, naphthyl, anthryl, phenanthryl, and the like. The alkyl substituent(s) can be, for example, methyl, ethyl, propyl, butyl, pentyl, hexyl, heptyl, octyl, nonyl, decyl, isomers thereof, and the like.

Preferred hydrocarbon-substituted diarylamines are those disclosed in U.S. Pat. Nos. 3,452,056 and 3,505,225, the disclosures of which are incorporated by reference herein. Preferred hydrocarbon-substituted diarylamines can be represented by the following general formulas: 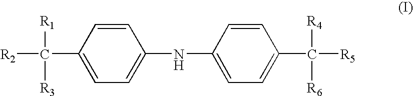
where

R₁ is selected from the group consisting of phenyl and p-tolyl radicals;

R₂ and R₃ are independently selected from the group consisting of methyl, phenyl, and p-tolyl radicals;

R₄ is selected from the group consisting of methyl, phenyl, p-tolyl, and neopentyl radicals;

R₅ is selected from the group consisting of methyl, phenyl, p-tolyl, and 2-phenylisobutyl radicals; and,

R₆ is a methyl radical. 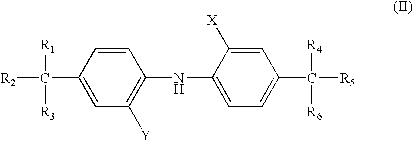
where

R₁ through R₅ are independently selected from the radicals shown in Formula I and R₇ is selected from the group consisting of methyl, phenyl, and p-tolyl radicals;

X is a radical selected from the group consisting of methyl, ethyl, C₃-C₁₀ sec-alkyl, α,α-dimethylbenzyl, α-methylbenzyl, chlorine, bromine, carboxyl, and metal salts of the carboxylic acids where the metal is selected from the group consisting of zinc, cadmium, nickel, lead, tin, magnesium, and copper; and,

Y is a radical selected from the group consisting of hydrogen, methyl, ethyl, C₃-C₁₀ sec-alkyl, chlorine, and bromine. 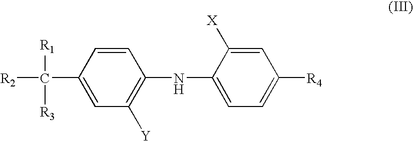
where

R₁ is selected from the group consisting of phenyl or p-tolyl radicals;

R₂ and R₃ are independently selected from the group consisting of methyl, phenyl, and p-tolyl radicals;

R₄ is a radical selected from the group consisting of hydrogen, C₃-C₁₀ primary, secondary, and tertiary alkyl, and C₃-C₁₀ alkoxyl, which may be straight chain or branched; and

X and Y are radicals independently selected from the group consisting hydrogen, methyl, ethyl, C₃-C₁₀ sec-alkyl, chlorine, and bromine. 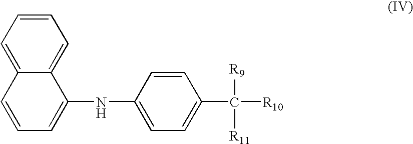
where

R₉ is selected from the group consisting of phenyl and p-tolyl radicals;

R₁₀ is a radical selected from the group consisting of methyl, phenyl, p-tolyl and 2-phenyl isobutyl; and

R₁₁ is a radical selected from the group consisting methyl, phenyl, and p-tolyl. 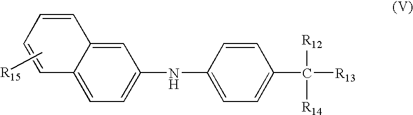
where

R₁₂ is selected from the group consisting of phenyl or p-tolyl radicals;

R₁₃ is selected from the group consisting of methyl, phenyl, and p-tolyl radicals;

R₁₄ is selected from the group consisting of methyl, phenyl, p-tolyl, and 2-phenylisobutyl radicals; and

R₁₅ is selected from the group consisting of hydrogen, α,α-dimethylbenzyl, α-methylbenzhydryl, triphenylmethyl, and α,α p-trimethylbenzyl radicals. Typical chemicals useful in the invention are as follows:

TYPE I

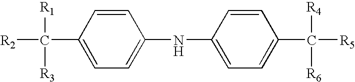

| R₁ | R₂ | R₃ | R₄ | R₅ | R₆ |
|---|---|---|---|---|---|
| Phenyl | Methyl | Methyl | Phenyl | Methyl | Methyl |
| Phenyl | Phenyl | Methyl | Phenyl | Phenyl | Methyl |
| Phenyl | Phenyl | Phenyl | Neopentyl | Methyl | Methyl |

TYPE II

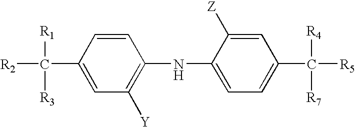

| R₁ | R₂ | R₃ | R₄ | R₅ | R₇ | X | Y |
|---|---|---|---|---|---|---|---|
| Phe- | Methyl | Methyl | Phe- | Methyl | Methyl | α,α- | Hydro- |
| nyl | | | nyl | | | Dimethyl- | gen |
| | | | | | | benzyl | |
| Phe- | Methyl | Methyl | Phe- | Methyl | Methyl | Bromo | Bromo |
| nyl | | | nyl | | | | |
| Phe- | Methyl | Methyl | Phe- | Methyl | Methyl | Carboxyl | Hydro- |
| nyl | | | nyl | | | | gen |
| Phe- | Methyl | Methyl | Phe- | Methyl | Methyl | Nickel | Hydro- |
| nyl | | | nyl | | | carbox- | gen |
| | | | | | | ylate | |
| Phe- | Methyl | Methyl | Phe- | Methyl | Methyl | 2-Butyl | Hydro- |
| nyl | | | nyl | | | | gen |
| Phe- | Methyl | Methyl | Phe- | Methyl | Methyl | 2-Octyl | Hydro- |
| nyl | | | nyl | | | | gen |
| Phe- | Phenyl | Phenyl | Phe- | Phenyl | Phenyl | 2-Hexyl | Hydro- |
| nyl | | | nyl | | | | gen |

TYPE III

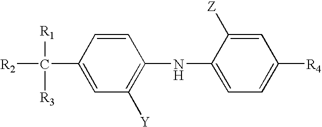

| R₁ | R₂ | R₃ | R₄ | X | Y |
|---|---|---|---|---|---|
| Phenyl | Methyl | Methyl | Isopropoxy | Hydrogen | Hydrogen |
| Phenyl | Methyl | Methyl | Hydrogen | 2-Octyl | Hydrogen |
| Phenyl | Phenyl | Phenyl | Hydrogen | 2-Hexyl | Hydrogen |

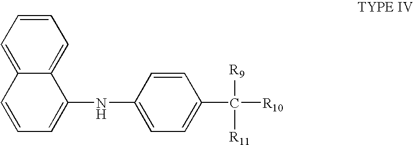 R₉ is phenyl and R₁₀ and R₁₁ are methyl.

A second class of amine antioxidants comprises the reaction products of a diarylamine and an aliphatic ketone. The diarylamine aliphatic ketone reaction products that are useful herein are disclosed in U.S. Pat. Nos. 1,906,935; 1,975,167; 2,002,642; and 2,562,802. Briefly described, these products are obtained by reacting a diarylamine, preferably a diphenylamine, which may, if desired, possess one or more substituents on either aryl group, with an aliphatic ketone, preferably acetone, in the presence of a suitable catalyst. In addition to diphenylamine, other suitable diarylamine reactants include dinaphthyl amines; p-nitrodiphenylamine; 2,4-dinitrodiphenylamine; p-aminodiphenylamine; p-hydroxydiphenylamine; and the like. In addition to acetone, other useful ketone reactants include methylethylketone, diethylketone, monochloroacetone, dichloroacetone, and the like.

A preferred diarylamine-aliphatic ketone reaction product is obtained from the condensation reaction of diphenylamine and acetone (NAUGARD A, Crompton Corp.), for example, in accordance with the conditions described in U.S. Pat. No. 2,562,802. The commercial product is supplied as a light tan-green powder or as greenish brown flakes and has a melting range of 85° to 95° C.

A third class of suitable amines comprises the N,N′ hydrocarbon substituted p-phenylene diamines. The hydrocarbon substituent may be alkyl or aryl groups, which can be substituted or unsubstituted. As used herein, the term “alkyl,” unless specifically described otherwise, is intended to include cycloalkyl. Representative materials are:
N-phenyl-N′-cyclohexyl-p-phenylenediamine;
N-phenyl-N′-sec.-butyl-p-phenylenediamine;
N-phenyl-N′-isopropyl-p-phenylenediamine;
N-phenyl-N′-(1,3-dimethylbutyl)-p-phenylenediamine;
N,N′-bis-(1,4-dimethylpentyl)-p-phenylenediamine;
N,N′-diphenyl-p-phenylenediamine;
mixed diaryl-p-N,N′-bis-(1-ethyl-3-methylpentyl)-p-phenylenediamine; and
N,N′-bis-(1 methylheptyl)-p-phenylenediamine.

A final class of amine antioxidants comprises materials based on quinoline, especially, polymerized 1,2-dihydro-2,2,4-trimethylquinoline. Representative materials include polymerized 2,2,4-trimethyl-1,2-dihydroquinoline; 6-dodecyl-2,2,4-trimethyl-1,2-dihydroquinoline; 6-ethoxy-2,2,4-trimethyl-1-2-dihydroquinoline, and the like.

Examples of useful hindered phenols include 2,4-dimethyl-6-octyl-phenol; 2,6-di-t-butyl-4-methyl phenol (i.e., butylated hydroxy toluene); 2,6-di-t-butyl-4-ethyl phenol; 2,6-di-t-butyl-4-n-butyl phenol; 2,2′-methylenebis(4-methyl-6-t-butyl phenol); 2,2′-methylenebis(4-ethyl-6-t-butyl-phenol); 2,4-dimethyl-6-t-butyl phenol; 4-hydroxymethyl-2,6-di-t-butyl phenol; n-octadecyl-beta(3,5-di-t-butyl-4-hydroxyphenyl)propionate; 2,6-dioctadecyl-4-methyl phenol; 2,4,6-trimethyl phenol; 2,4,6-triisopropyl phenol; 2,4,6-tri-t-butyl phenol; 2-t-butyl-4,6-dimethyl phenol; 2,6-methyl-4-didodecyl phenol; tris(3,5-di-t-butyl-4-hydroxy isocyanurate, and tris(2-methyl-4-hydroxy-5-t-butylphenyl)butane.

Other useful antioxidants include 3,5-di-t-butyl-4-hydroxy hydrocinnamate; octadecyl-3,5-di-t-butyl-4-hydroxy hydrocinnamate (NAUGARD 76, Crompton Corp.; IRGANOX 1076, Ciba-Geigy); tetrakis{methylene(3,5-di-t-butyl-4-hydroxy-hydrocinnamate)}methane (IRGANOX 1010, Ciba-Geigy); 1,2-bis(3,5-di-t-butyl-4-hydroxyhydrocinnamoyl)hydrazine (IRGANOX MD 1024,Ciba-Geigy); 1,3,5-tris(3,5-di-t-butyl-4-hydroxybenzyl)-s-triazine-2,4,6 (1H,3H,5H)trione (IRGANOX 3114,Ciba-Geigy); 2,2′-oxamido bis-{ethyl-3-(3,5-di-t-butyl-4-hydroxyphenyl)}propionate (NAUGARD XL-1, Crompton Corp.); 1,3,5-tris(4-t-butyl-3-hydroxy-2,6-dimethylbenzyl)-s-triazine-2,4,6-(1H,3H,5H)trione (CYANOX 1790, American Cyanamid Co.); 1,3,5-trimethyl-2,4,6-tris(3,5-di-t-butyl-4-hydroxybenzyl)benzene (ETHANOX 330, Ethyl Corp.); 3,5-di-t-butyl-4-hydroxyhydrocinnamic acid triester with 1,3,5-tris(2-hydroxyethyl)-5-triazine-2,4,6(1H,3H,5H)-trione, and bis(3,3-bis(4-hydroxy-3-t-butylphenyl)butanoic acid)glycolester.

Still other hindered phenols that are useful in the practice of the present invention are polyphenols that contain three or more substituted phenol groups, such as tetrakis{methylene (3,5-di-t-butyl-4-hydroxy-hydrocinnamate)}methane (IRGANOX 1010, Ciba-Geigy) and 1,3,5-trimethyl-2,4,6-tris(3,5-di-t-butyl-4-hydroxybenzyl)benzene (ETHANOX 330, Ethyl Corp.).

Specifically, a blend comprising 4,4′-bis(α,α-dimethylbenzyl)diphenylamine and tetrakis [methylene (3,5-di-t-butyl-4-hydroxyhydrocinnamate)]methane provided performance superior to a control blend of tris(2,4-di-t-butylphenyl)phosphite and tetrakis [methylene (3,5-di-t-butyl-4-hydroxyhydrocinnamate)]methane.

A preferred composition is one comprising a blend of 4,4′-bis(α,α-dimethylbenzyl)diphenylamine and tetrakis [methylene (3,5-di-t-butyl-4-hydroxyhydrocinnamate)]methane.

It is preferred that the weight ratio of the two components be 1:1, although ratios in the range of 1:9 to 9:1 can be employed.

The thermoplastic resins that can be stabilized by the blends of the present invention include, but are not limited to, polyolefins. Such polyolefins are typically polymerized from ethylene, propylene, and/or other alpha olefins. Where ethylene is used, it can be, for example, high density polyethylene (HDPE), low density polyethylene (LDPE), or linear low density polyethylene (LLDPE). Polypropylene homopolymer, as well as copolymers and terpolymers containing ethylene, propylene, and/or other alpha olefins, and/or non-conjugated dienes can also be advantageously employed, as can blends of these polymers.

Thus, such polyolefin materials can, if desired, comprise either a polypropylene copolymer wherein the polymer comprises a major proportion of propylene combined with a minor proportion (typically less than 50 wt %, more commonly between about 0.1 and 10 wt %) of a second monomer that can comprise ethylene or a C₄-C₁₆ monomer material. Preferred ethylene copolymers can comprise a major proportion of ethylene and a minor proportion (typically less than 50 wt %, preferably about 0.1 to about 10 wt %) of a C₃-C₁₈ monomer.

HDPE, i.e., high density polyethylene, is most preferred as the thermoplastic resin stabilized by blends of the present invention.

A particulate filler may be included with the thermoplastic resins employed in the practice of the present invention, including siliceous fillers, carbon black, and the like. Such filler materials include, but are not limited to, metal oxides such as silica (pyrogenic and precipitated), titanium dioxide, aluminosilicate and alumina, clays and talc, carbon black, mixtures of the foregoing, and the like. Carbon black is preferred.

Thus, when a (natural) HDPE test coupon stabilized with a blend of an aromatic amine and a hindered phenol was immersed in hot chlorinated water, it gave better resistance to the deleterious effect of chlorine than a corresponding test coupon containing the phosphite based control. This performance advantage was recorded by Oxidation Induction Time.

Secondly, when a carbon black containing HDPE test coupon stabilized with a blend of an aromatic amine and a hindered phenol was immersed in hot chlorinated water, it too gave better resistance to the deleterious effect of chlorine than a corresponding carbon black containing test coupon containing the phosphite based control. This performance advantage, again, was recorded by Oxidation Induction Time.

Improved resistance for the blend comprising an aromatic amine and a hindered phenol stabilizer was further verified even in hot water alone, in the absence of chlorine.

Thus, when a HDPE test coupon stabilized with a blend of an aromatic amine and a hindered phenol was immersed in 60° C. water, it provided a better stabilizing effect than a corresponding test coupon containing the phosphite based control, as measured by Oxidation Induction Time.

Next, when a carbon black containing HDPE test coupon stabilized with a blend of an aromatic amine and a hindered phenol was immersed in 60° C. water, it afforded better stabilization than a corresponding carbon black containing test coupon containing the phosphite based control, as was recorded by Oxidation Induction Time.

The advantages and the important features of the present invention will be more apparent from the following examples.

### EXAMPLES

### Differential Scanning Calorimetry

Differential Scanning Calorimetry was performed using a Mettler 820 instrument equipped with Mettler Star software version 7.01. Test specimens containing no carbon black were evaluated in aluminum pans. Test specimens containing carbon black were analyzed in copper pans. Oxidation Induction Time (OIT) was measured by heating, under nitrogen, the appropriate pan containing a circular disk harvested from a test coupon to a temperature of 200° C. At that point, while holding a temperature of 200° C., an oxygen atmosphere was introduced. OIT was recorded as the time elapsed until the onset of the curve. Higher OIT numbers indicate better protection and/or less stabilizer depletion.

### Test Coupon Preparation and Aging Experiment

Test coupons were prepared by first mixing a high density polyethylene powder having a density of approximately 0.944 g/cm³ with the appropriate additive(s) in a Brabender mixing head at 200° C./50 rpm for 15 minutes. The resultant pancake was then used to produce test coupons having a thickness of 10 mils by compression molding. For aging experiments, an appropriate test coupon was placed into a jar filled with either deionized water or a chlorinated water solution prepared in accordance with the procedure of Example 1, below. The jar was then placed into a circulating hot air oven whose temperature was set to 60° C.

### EXAMPLE 1

### Preparation of a Chlorinated Water Test Solution

Four mL of commercially available Clorox bleach having an active sodium hypochlorite concentration of 5.25% was added to a 2 L volumetric flask. The flask was then filled with deionized water to the calibration mark. The resultant solution contained approximately 100 ppm of active sodium hypochlorite.

### EXAMPLE 2

Stabilizing Effect of a Blend
Comprising and Aromatic Amine and a Hindered Phenol in HDPE

| | | OIT (Minutes) @ 200° C. | | |
|---|---|---|---|---|
| | | | After One Week Aging | |
| | | | at 60° C. | |
| | | | Deionized | Chlorinated |
| Test Coupon Formulation | Code | Unaged | Water | Water |
| HDPE + 0.125% | Control 1 | 105 | 106 | 3 |
| PHOS-1 + | | | | |
| 0.125% PAO-1 | | | | |
| HDPE + 0.125% | A | 132 | 114 | 25 |
| AM-1 + | | | | |
| 0.125% PAO-1 | | | | |

PHOS-1 is tris(2,4-di-tert-butylphenyl)phosphite.
PAO-1 is tetrakis[methylene(3,5-di-t-butyl-4-hydroxyhydrocinamate)]methane.
AM-1 is 4,4‘-bis(α,α-dimethylbenzyl)diphenylamine.

The results from this testing show that Code A, which was made up from a stabilizing blend of a secondary aromatic amine and sterically hindered phenol, gave superior performance compared to a phosphite-based formulation (Control 1). That performance advantage was observed for both hot water (no chlorine) and hot chlorinated water.

### EXAMPLE 3

Stabilizing Effect of a Blend Comprising and Aromatic Amine and a
Hindered Phenol in HDPE in the Presence of Carbon Black.

| | | OIT (Minutes) @ 200° C. | | |
|---|---|---|---|---|
| | | | After One Week Aging | |
| | | | at 60° C. | |
| | | | Deionized | Chlorinated |
| Test Coupon Formulation | Code | Unaged | Water | Water |
| HDPE + 0.125% | Control 2 | 73 | 61 | 5 |
| PHOS-1 + 0.125% | | | | |
| PAO-1 + 2.25% | | | | |
| Carbon Black | | | | |
| HDPE + 0.125% | B | 99 | 98 | 21 |
| AM-1 + 0.125% | | | | |
| PAO-1 + 2.25% | | | | |
| Carbon Black | | | | |

For carbon black-containing formulations the results from this testing show that code B, which was made up from a stabilizing blend of a secondary aromatic amine and sterically hindered phenol, gave superior performance compared to a phosphite based formulation, Control 2. The performance advantage was noted for both hot water and chlorinated hot water. In view of the many changes and modifications that can be made without departing from principles underlying the invention, reference should be made to the appended claims for an understanding of the scope of the protection to be afforded the invention.

What is claimed is:

1. A method for increasing the stability of a thermoplastic resin in the presence of water comprising adding to said resin a stabilizing amount of a blend of:
(A) at least one aromatic amine antioxidant; and
(B) at least one sterically hindered phenol antioxidant.

2. The method of claim 1 wherein the water is chlorinated.

3. The method of claim 1 wherein the thermoplastic resin is a polyolefin.

4. The method of claim 3 wherein the polyolefin is high density polyethylene.

5. The method of claim 1 wherein the aromatic amine antioxidant is represented by the formula:
Ar—NH—Ar′
wherein Ar and Ar′ are independently selected substituted or unsubstituted aryl radicals.

6. The method of claim 5 wherein the aromatic amine antioxidant is 4,4′-bis(α,α-dimethylbenzyl)diphenylamine.

7. The method of claim 2 wherein the aromatic amine antioxidant is 4,4′-bis(α,α-dimethylbenzyl)diphenylamine.

8. The method of claim 7 wherein the thermoplastic resin is a polyolefin.

9. The method of claim 8 wherein the polyolefin is high density polyethylene.

10. A pipe for transporting water wherein said pipe is prepared from a composition comprising a thermoplastic resin and a stabilizing amount of a blend of:
(A) at least one aromatic amine antioxidant; and
(B) at least one sterically hindered phenol antioxidant.

11. The pipe of claim 10 wherein the water is chlorinated.

12. The pipe of claim 10 wherein the thermoplastic resin is a polyolefin.

13. The pipe of claim 12 wherein the polyolefin is high density polyethylene.

14. The pipe of claim 10 wherein the aromatic amine antioxidant is represented by the formula:
Ar—NH—Ar′
wherein Ar and Ar′ are independently selected substituted or unsubstituted aryl radicals.

15. The pipe of claim 14 wherein the aromatic amine antioxidant is 4,4′-bis(α,α-dimethylbenzyl)diphenylamine.

16. The pipe of claim 11 wherein the aromatic amine antioxidant is 4,4′-bis(α,α-dimethylbenzyl)diphenylamine.

17. The pipe of claim 16 wherein the thermoplastic resin is a polyolefin.

18. The pipe of claim 17 wherein the polyolefin is high density polyethylene.
